(19) United States
(12) Patent Application Publication
(10) Pub. No.: US 2006/0018500 A1
(43) Pub. Date: Jan. 26, 2006

(54) Speaker device and method of manufacturing the speaker device

(76) Inventor: Tomoyuki Watanabe, Yamagata (JP)

Correspondence Address: YOUNG & THOMPSON, 745 SOUTH 23RD STREET, 2ND FLOOR, ARLINGTON, VA, 22202, US

(21) Appl. No.: 11/084,114

(22) Filed: Mar. 21, 2005

(30) Foreign Application Priority Data
Mar. 19, 2004 (JP) 2004-80186

(51) Int. Cl. H04R 25/00

(52) U.S. Cl. 381/398; 381/396

(57) ABSTRACT

A speaker device includes a terminal member, a connecting member, a conductive damper and a diaphragm. The connecting member has a terminal mounting part. The terminal mounting part has a projecting part and a connecting part. The connecting member has a hole in its upper end portion and a fixing part at its lower end portion. The terminal member is mounted to the terminal mounting part. At this time, the projecting part is inserted into the hole, and the fixing part is inserted into a groove. Thereby, at positions of two spots, the terminal member is physically fixed to the connecting member. The connecting part is connected to the conductive member of the conductive damper. Thus, a soldering operation of the connecting part and the conductive member can be performed easily. Then soldering is performed for the terminal member, a lead wire of a voice coil and the conductive member.

### TECHNICAL FIELD

The present invention relates to a fixing structure of a connecting member and a terminal member in a speaker device.

### BACKGROUND ART

An internal magnet type speaker device including a magnetic circuit including a planar magnet, a planar plate and a pot-shaped yoke, and a vibration system including a terminal member having conductivity, a conductive damper made by weaving a conductive member, a connecting member made of a resin material, a voice coil, a voice coil bobbin and a frame is conventionally known.

In such a speaker device, the connecting member movably supports the voice coil bobbin. Therefore, it is necessary to electrically connect lead wires of the voice coil and the conductive damper through an area in the vicinity of the connecting member.

A wiring structure to a conductive part on the damper, which facilitates the wiring operation and the like of an end part of the conductive part of the conductive damper and a terminal is known (for example, see Japanese Utility Model Publication No. 7-49908).

### DISCLOSURE OF THE INVENTION

As an object to be achieved by the present invention, the above described object is cited as an example. The present invention has its object to provide a speaker device having a fixing structure of a terminal member and a connecting member by which the number of assembling steps of the speaker device can be reduced.

According to one aspect of the present invention, a speaker device includes a frame, a damper with an outer peripheral edge portion supported by the frame, a connecting member mounted to the damper and movably supporting a voice coil bobbin, and a terminal member electrically connected to an amplifier side and a voice coil side, wherein a projecting part projecting upward is formed at an upper end portion of the connecting member and a groove is formed in a lower end portion of the connecting member, wherein a hole in which the projecting part is inserted is formed in an upper end portion of the terminal member and a fixing part which is inserted into the groove is formed at a lower end portion of the terminal member, and wherein the terminal member is mounted to the connecting member in a state in which the projecting part is inserted into the hole and the fixing part is inserted into the groove.

In the above described speaker device, the hole is formed in the upper end portion of the terminal member and the fixing part is formed at the lower end portion of the terminal member. Meanwhile, the projecting part is formed at the upper end portion of the connecting member and the groove is formed in the lower end portion of the connecting member. Therefore, the terminal member can be physically fixed to the connecting member at the two positions by inserting the projecting part into the hole, and inserting the fixing part into the groove. Thereby, fixing strength of the terminal member and the connecting member can be enhanced.

In one mode of the above described speaker device, a projecting part projecting to a side of a center axis of the connecting member is formed in the groove, an opening into which the projecting part is inserted is formed in the fixing part, and the projecting part is inserted into the opening.

According to this mode, the projecting part projecting to the side of the center axis is formed in the groove of the connecting member. Meanwhile, the opening into which the projecting part is inserted is formed in the fixing part of the terminal member. The terminal member is mounted to the connecting member in the state in which the projecting part is inserted into its opening. Therefore, the terminal member has the structure in which it is difficult to release from the connecting member. Therefore, connecting strength of the terminal member and the connecting member can be further enhanced.

In another mode of the above described speaker device, a connecting part of the terminal member is connected to a conductive member of a conductive damper or a tinsel cord. Thereby, the connecting part of the terminal member is connected to the conductive member of the conductive damper or the tinsel cord by mounting the terminal member to the connecting member. Since the terminal member is fixed to the connecting member, the terminal member does not lift from the connecting member. Therefore, the soldering operation for the connecting part of the terminal member and the conductive member of the conductive damper or the tinsel cord can be easily performed. Thus, the connecting member, the conductive damper and the terminal member can be simultaneously bonded. Thus, the connecting member, the conductive damper and the terminal member can be firmly bonded by one adhesive applying operation. Therefore, reduction of the number of assembling steps of the speaker device can be achieved.

In another mode of the above described speaker device, an inner peripheral edge portion of a diaphragm is disposed at the upper end portion of the terminal member.

According to this mode, the upper end portion of the connecting member, the upper end portion of the terminal member and the inner peripheral portion of the diaphragm can be simultaneously bonded. Thus, the connecting member, the diaphragm and the terminal member can be firmly bonded by one adhesive applying operation. Therefore, reduction of the number of assembling steps of the speaker device can be achieved.

In another aspect of the present invention, a method of manufacturing a speaker device has the steps of fixing a terminal member to a connecting member by inserting a projecting part formed at an upper end portion of the connecting member into a hole formed in an upper end portion of the terminal member and inserting a fixing part formed at a lower end portion of the terminal member into a groove formed at a lower end portion of the connecting member, soldering a connecting part of the terminal member fixed to the connecting member and a conductive member of a conductive damper and soldering a lead wire of a voice coil to the upper end portion of the terminal member, simultaneously bonding the upper end portion of the terminal member, the upper end portion of the connecting member and the inner peripheral edge portion of the diaphragm, and simultaneously bonding the lower end portion of the terminal member, the lower end portion of the connecting member and the inner peripheral edge portion of the conductive damper.

According to the above described manufacturing method of the speaker device, the terminal member can be fixed to the connecting member by inserting the projecting part formed at the upper end portion of the connecting member into the hole formed in the upper end portion of the terminal member, and inserting the fixing part formed at the lower end portion of the terminal member into the groove formed in the lower end part of the connecting member. Thus, the fixing strength of the terminal member and the connecting member can be enhanced.

The connecting part of the terminal member fixed to the connecting member and the conductive member of the conductive damper can be soldered. Since the terminal member is reliably fixed without lifting from the connecting member, the soldering operation of the connecting part of the terminal member and the conductive member of the conductive damper can be easily performed. The portion of the lead wire of the voice coil connected to the upper end portion of the terminal member can be soldered. Thereby, the voice coil and the conductive damper are electrically connected.

The upper end portion of the terminal member, the upper end portion of the connecting member and the inner peripheral portion of the diaphragm are simultaneously bonded. Thus, the connecting member, the diaphragm and the terminal member can be bonded by one adhesive applying operation. Thereby, reduction of the number of assembling steps of the speaker device can be achieved.

The lower end portion of the terminal member, the lower end portion of the connecting member and the inner peripheral edge portion of the conductive damper can be simultaneously bonded. Thus, the connecting member, the conductive damper and the terminal member can be bonded by one adhesive applying operation. Thereby, reduction of the number of assembling steps of the speaker device can be achieved.

### BRIEF DESCRIPTION OF THE DRAWINGS

FIG. 1 shows a sectional view of a speaker device according to an embodiment of the present invention;

FIG. 2 shows a plane view of a conductive damper according to this embodiment;

FIGS. 3A to 3C show perspective views of a terminal member according to a first embodiment;

FIG. 4 shows a perspective view of a connecting member according to the first embodiment;

FIG. 5A shows a sectional view of a connecting member according to the first embodiment and FIG. 5B shows a plane view thereof;

FIG. 6 is a perspective view of a local part of the connecting member and the like according to the first embodiment, showing a method for mounting the terminal member to the connecting member;

FIGS. 7A and 7B are sectional views of a local part of the speaker device according to the first embodiment in the state in which the terminal member is mounted to the connecting member;

FIG. 8 is a perspective view of a local part of the connecting member and the like according to the first embodiment, showing a connecting method of a lead wire and the terminal member;

FIG. 9 shows a perspective view of a terminal member according to a second embodiment;

FIG. 10 shows a perspective view of a connecting member according to the second embodiment;

FIG. 11A shows a sectional view of the connecting member according to the second embodiment, and FIG. 11B shows a plane view thereof;

FIG. 12 is a perspective view of a local part of the connecting member and the like according to the second embodiment, showing a method for mounting the terminal member to the connecting member;

FIGS. 13A and 13B are sectional views of local parts of the speaker device according to the second embodiment in the state in which the terminal member is mounted to the connecting member;

FIGS. 14A to 14D show perspective views and sectional views of connecting members according to modified examples;

FIG. 15 shows a sectional view of a speaker device in which a fixing structure of the present invention is applied to a speaker having a tinsel cord;

FIG. 16 shows a sectional view of a speaker device in which the fixing structure of the present invention is applied to the speaker device having the tinsel cord;

FIGS. 17A to 17D are perspective views showing various kinds of modes of the terminal members applicable to the speaker devices in FIG. 15 and FIG. 16;

FIG. 18 shows a flow chart of a manufacturing method of the speaker device;

FIG. 19 shows a sectional view of a manufacturing process of the speaker device;

FIG. 20 shows a sectional view of the manufacturing process of the speaker device;

FIGS. 21A and 21B show sectional views of local parts of the speaker device; and

FIGS. 22A and 22B show sectional views of the local parts of the speaker device.

### BEST MODE FOR CARRYING OUT THE INVENTION

A preferred embodiment of the present invention will be explained hereinafter with reference to the drawings. In this embodiment, fixing structures are provided in at least two spots that are a terminal member and a connecting member.

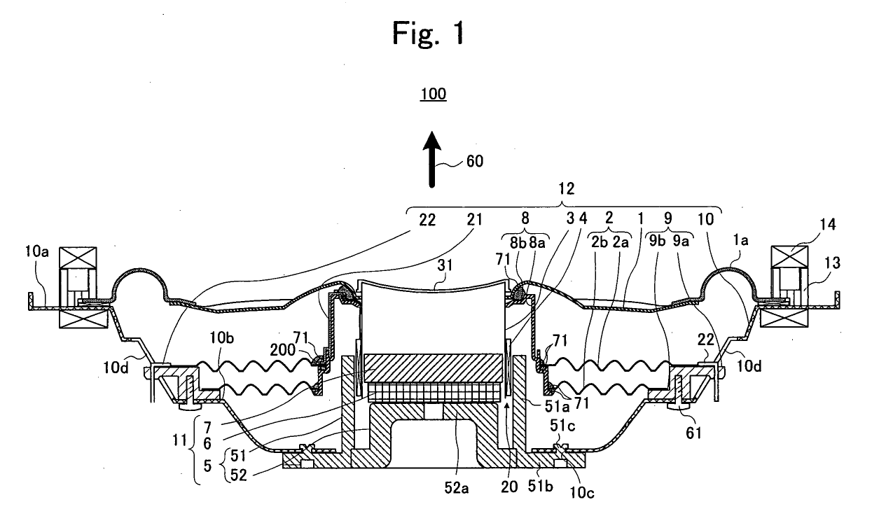

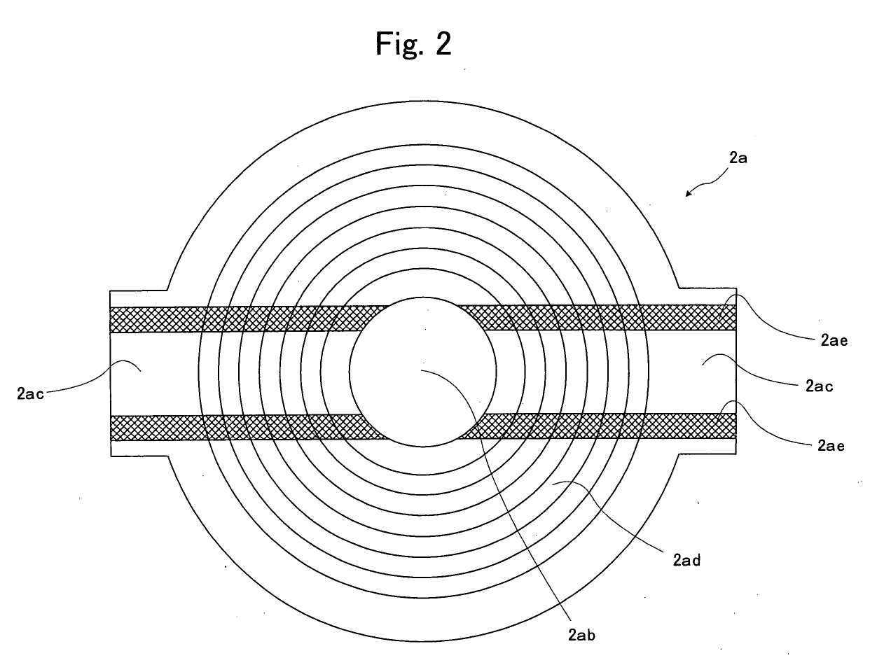

FIG. 1 schematically shows a construction of a speaker device 100 according to the embodiment of the present invention. The speaker device 100 of this embodiment can be preferably used as the on-vehicle speaker. FIG. 1 shows a sectional view when cutting the speaker device 100 by a plane including a center axis thereof. FIG. 2 schematically shows a plane view of a conductive damper 2a. Referring to FIGS. 1 and 2, the construction and the like of the speaker device 100 of this embodiment will be explained hereinafter.

As shown in FIG. 1, the speaker device 100 mainly includes a vibration system 12 having a frame 10, a support member 9, a voice coil bobbin 3, a connecting member 8, a damper 2, terminal members 21, terminal members 22, a voice coil 4 and a diaphragm 1, a magnetic circuit system 11 having a pot type yoke 5, a magnet 6 and a plate 7, and an antidust cap 31 and various kinds of other members.

First, each of the components of the vibration system 12 will be explained.

Various components of the speaker device 100 are fixed to the frame 10, and the frame 10 has the function of supporting these components. The frame 10 is made of a metal material with favorable thermal conductivity. Therefore, the frame 10 has the function of a medium which transmits heat between an external space of the speaker device 100 and an internal space thereof. The frame 10 is formed into a pan-shape or a pot-shape which is opened upward, and has a first flange part 10a which is formed at an upper part and supports an outer peripheral edge portion or the like of the diaphragm 1, a second flange part 10b which is formed at an intermediate part and supports the support member 9, openings 10c formed in an inner peripheral edge portion, and a plurality of openings 10d formed at a side wall between the first flange part 10a and the flange part 10b. A plurality of openings 10c are formed in a circumferential direction of the inner peripheral edge portion with constant spaces between them. Each of projecting portions 51c of the pot-type yoke 5 before deformation, which will be described later, is inserted in each of the openings 10c.

The support member 9 is made of, for example, a resin material, and is formed into a substantially annular shape in the plane view. The support member 9 is formed into a step shape in the sectional view, and has an upper surface 9a and an upper surface 9b. The support member 9 is mounted to the second flange part 10b by a fixing member 61 such as a male screw and a bolt, for example.

The voice coil bobbin 3 is formed into a substantially cylindrical shape. The voice coil 4 is wound around an outer peripheral wall of a lower end portion of the voice coil bobbin 3. An inner peripheral wall of the lower end portion of the voice coil bobbin 3 is opposed to outer peripheral walls of the planar magnet 6 and plate 7 with a fixed space from them. Further, the outer peripheral wall of the lower end portion of the voice coil bobbin 3 is opposed to an outer peripheral wall of an upper end portion of a pole piece 5 with a fixed space apart from it. A clearance (a magnetic gap 20) is formed between the inner peripheral wall of the upper end portion of the pole piece 5 and the outer peripheral wall of the plate 7.

The connecting member 8 is made of a resin material, for example, and has a cylinder portion 8a formed into a substantially cylindrical shape and a bent portion 8b formed in a fashion being bent inwardly from an upper end of the cylinder portion 8a, and is made by integrally forming them. An inner peripheral edge portion of the connecting member 8, namely, the inner peripheral edge portion of the bent portion 8b is fixed to the vicinity of an upper end of the outer peripheral wall of the voice coil bobbin 3. The detailed construction of the connecting member 8 having a fixing structure of the present invention will be described later.

The damper 2 has a conductive damper 2a and an ordinary damper 2b.

The conductive damper 2a is disposed above the damper 2b. The conductive damper 2a includes an opening 2ab, a plurality of projecting parts 2ac, an elastic part 2ad and a plurality of conductive members 2ae.

The opening 2ab is formed substantially at a center of the conductive damper 2a. The connecting member 8 is inserted into this opening 2ad. A plurality of projecting parts 2ac are extended outside from an outer peripheral edge portion of the conductive damper 2a and are each formed into a substantially rectangular shape. The respective projecting parts 2ac are formed at the positions where they are symmetrical to each other as shown in FIG. 2. The respective projecting parts 2ac and the outer peripheral edge portion of the conductive damper 2a are respectively mounted to the upper surface 9a of the above described support member 9. The elastic part 2ad is formed into a corrugated shape, and plays a role of movably supporting the connecting member 8. A plurality of conductive members 2ae are formed by a conductive member and play a role of electrically connecting lead wires 4a of the voice coil 4 and the terminal members 21. Each of the conductive members 2ae is woven into a flat net shape at a top surface side of the conductive damper 2a from an inner peripheral edge portion of the conductive damper 2a to an end portion side of the projecting part 2ac. The conductive members 2ae at the side of the inner peripheral edge portion of the conductive damper 2a are electrically connected to connecting parts 21c of the respective positive/negative terminal members 21. Meanwhile, the conductive members 2ae at a side of the outer peripheral edge portion of the conductive damper 2a are electrically connected to one end sides of respective positive/negative terminal members 22.

The ordinary damper 2b is formed into substantially the same shape as the conductive damper 2a. However, the ordinary damper 2b does not have the conductive members 2ae unlike the conductive damper 2a. An outer peripheral edge portion of the ordinary damper 2b is fixed to the top surface 9b of the support member 9, and an inner peripheral edge portion of the damper 2b is fixed to the lower end portion of the connecting member 8 via an adhesive 71.

The terminal member 21 is a member of metal or the like having conductivity, and a plurality of the terminal members 21 are provided. Each of the terminal members 21 is mounted to the connecting member 8. The detailed construction of the terminal member 21 having the fixing structure of the present invention will be described later.

The terminal member 22 is a member having conductivity, and a plurality of terminal members 22 are provided. Each of the terminal members 22 is fixed to the top surface 9a of the support member 9. One end of each of the terminal members 22 is electrically connected to each of the conductive members of the conductive damper 2a, and the other end of each of the terminal members 22 is electrically connected to a relay wiring at the side of an amplifier not shown.

The voice coil 4 has a pair of plus/minus lead wires (not shown). The lead wire at the positive side is an input wiring for an L (or R)-channel signal, and the lead wire at the negative side is an input wiring for a ground (GND: ground) signal. Each of the lead wires is electrically connected to an upper end of each of the terminal members 21 as described above. Therefore, an electric signal of one channel is inputted into the voice coil 4 from the amplifier side via each of the terminal members 22, each of the conductive members of the conductive damper 2a, each of the terminal members 21 and each of the lead wires.

The diaphragm 1 is formed into a substantially planar shape to be made thin. Various kinds of materials such as paper, high polymer and metal can be applied to the diaphragm 1 in accordance with the various use purposes. An edge part 1a which is separate from the diaphragm 1 is mounted to an outer peripheral edge portion of the diaphragm 1. The outer peripheral edge portion of the diaphragm 1 is fixed to the first flange part 10a. Meanwhile, an inner peripheral edge portion of the diaphragm 1 is fixed to the vicinity of the upper end of the outer peripheral wall of the voice coil bobbin 3. The inner peripheral edge portion of the diaphragm 1 and the bent portion 8b of the connecting member 8 are fixed to each other via the adhesive 71.

Next, each component of the magnetic circuit system 11 will be explained.

The magnetic circuit system 11 is constructed as an internal magnet type magnetic circuit. This magnetic circuit has the pot type yoke 5, the planar magnet 6 and the planar plate 7.

The pot type yoke 5 has a body part 51 and a bottom part 52, and is formed by connecting them. The pot type yoke 5 is mounted to the frame 10.

The body part 51 has a cylinder part 51a, a flange part 51b and projecting parts 51c projecting upward from a top surface of the flange part 51b, and is made by integrally forming them. The cylindrical part 51a is formed into a substantially cylindrical shape. The cylinder part 51a extends upward from the vicinity of the inner periphery of the flange part 51b to the position in the vicinity of the plate 7. The flange part 51b extends in an outward direction substantially perpendicularly from the vicinity of the lower end of the outer peripheral wall of the cylindrical part 51a. The inner peripheral edge portion of the frame 10 is mounted to a top surface of the flange part 51b. The projecting part 51c is formed into a columnar shape, and a plurality of the projecting parts 51c are formed on the top surface of the flange part 51b with a constant space apart from each other. Each of the projecting parts 51c plays a role of fixing the inner peripheral edge portion of the frame 10 by being caulked.

The bottom part 52 has the sectional shape which is a substantially inversed recessed shape, and has a mounting part 52a which has substantially the same size as the diameters of the planar magnet 6 and the planar plate 7. The outer peripheral edge portion of the bottom part 52 is connected to the body part 51.

The planar magnet 6 is fixed onto the mounting part 52a of the bottom part 52 of the pot type yoke 5. The planar plate 7 is fixed onto the magnet 6. In the magnetic circuit system 11, the magnetic circuit is constructed by the magnet 6 and the plate 7, and a magnetic flux of the magnet 6 is concentrated to the magnetic gap 20 formed between the outer peripheral wall of the plate 7 and the inner peripheral wall of the pot type yoke 5.

The antidust cap 31 is mounted to an upper end portion of the voice coil bobbin 3 via an adhesive to close a top surface of the voice coil bobbin 3. Thereby, the antidust cap 31 has the function of preventing a foreign matter or the like from entering the inside of the speaker device 100.

Next, various kinds of components will be explained.

Various kinds of components include the members such as packing 13 and a buffering member 14.

The packing 13 is formed into an annular shape, and is a member having insulation properties. As a material of the packing 13, for example, a resin material is preferable. An undersurface of the packing 13 is fixed to the first flange part 10a and an outer peripheral edge portion of the edge part 1a, respectively. As a result, the outer peripheral edge portions of the diaphragm 1 and the edge part 1a are held between the packing 13 and the first flange part 10a.

The buffering member 14 has the function as the buffering member when the speaker device 100 is mounted to a predetermined position of a vehicle, for example, and has the function of preventing a vibration from an outside from being transmitted to the body of the speaker device 100. Therefore, a member of sponge or the like having cushioning properties is preferable as the material of the buffering member 14. The buffering member 14 is formed into a rod shape in the state before being mounted, with one side surface coated with an adhesive, or a double-side adhesive tape attached on the one side surface. The buffering member 14 is mounted on the top surface of the packing 13 via the adhesive or the double-side adhesive tape in the state in which it is deformed into an annular shape.

In the speaker device 100 described above, the electric signal outputted from the amplifier side is supplied to the voice coil 4 via each of the terminal parts 22, each of the conductive members of the conductive damper 2a, each of the terminal members 21, and each of the lead wires of the voice coil 4. Thereby, a driving force occurs to the voice coil 4 in the magnetic gap 20, which vibrates the diaphragm 1 in the axial direction of the speaker device 100. The speaker device 100 thus emits sound waves in the direction of the arrow 60.

[Fixing Structure and the like of Terminal Member and Connecting Member]

### First Embodiment

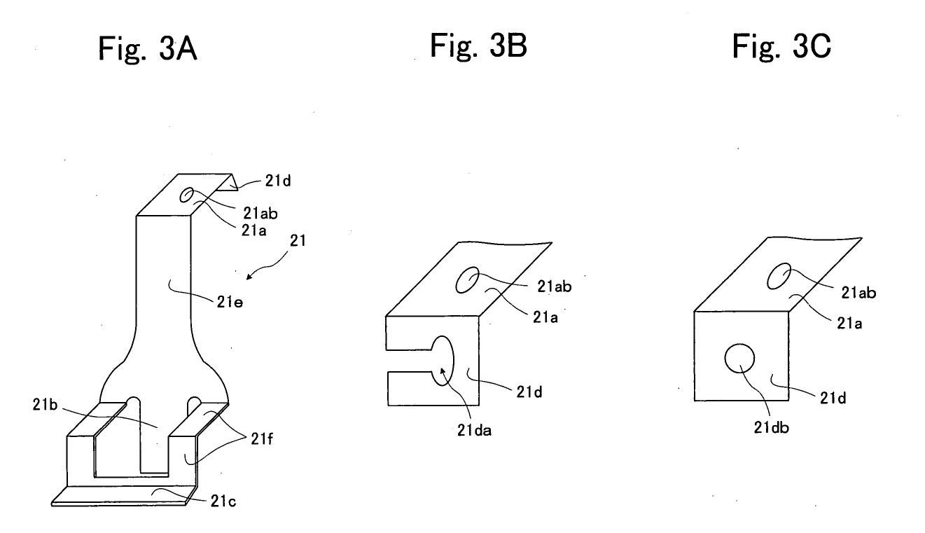

Next, referring to FIGS. 3 to 8, a fixing structure and the like of the terminal member 21 and the connecting member 8 according to the first embodiment which makes the characteristics of the present invention will be described in detail.

Explaining the outline of the first embodiment, in the first embodiment, a hole is provided in an upper end portion of the terminal member 21, and a fixing part is provided at a lower end portion of the terminal member 21. A projecting part is provided at an upper end portion of the connecting member 8, and a groove is provided in the vicinity of a lower end of the connecting member 8. The projecting part of the connecting member 8 is inserted into the hole of the terminal member 21, and the fixing part of the terminal member 21 is inserted into the groove of the terminal member 8, whereby the terminal member 21 is mounted to the connecting member 8. Thereby, the terminal member 21 is reliably fixed to the connecting member 8 without fixing the terminal member 21 to the connecting member 8 with the adhesive.

Thereby, at the same time when the bent portion 8b of the connecting member 8 is bonded to the inner peripheral edge portion of the diaphragm 1 with the adhesive, the upper end portion of the terminal member 21 is bonded to them. At the same time when the outer peripheral wall of the connecting member 8 and the inner peripheral edge portion of the conductive damper 2a are bonded with the adhesive, the lower end portion of the terminal member 21 is bonded to them. The coating operation of the adhesive is finished at one time, and thereby, the number of assembling steps of the speaker device is reduced.

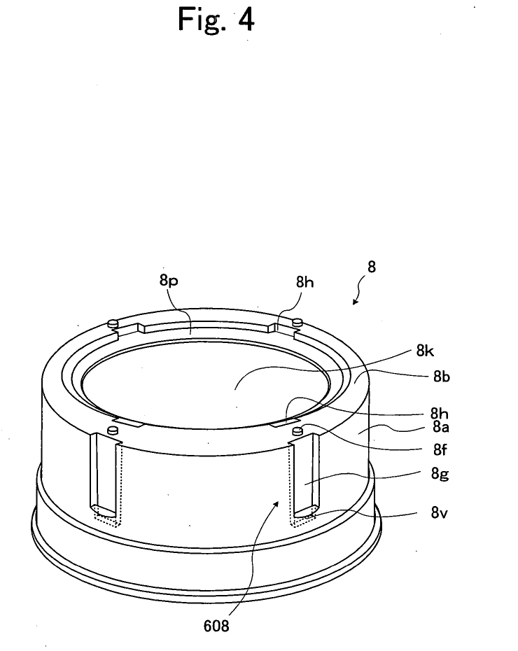

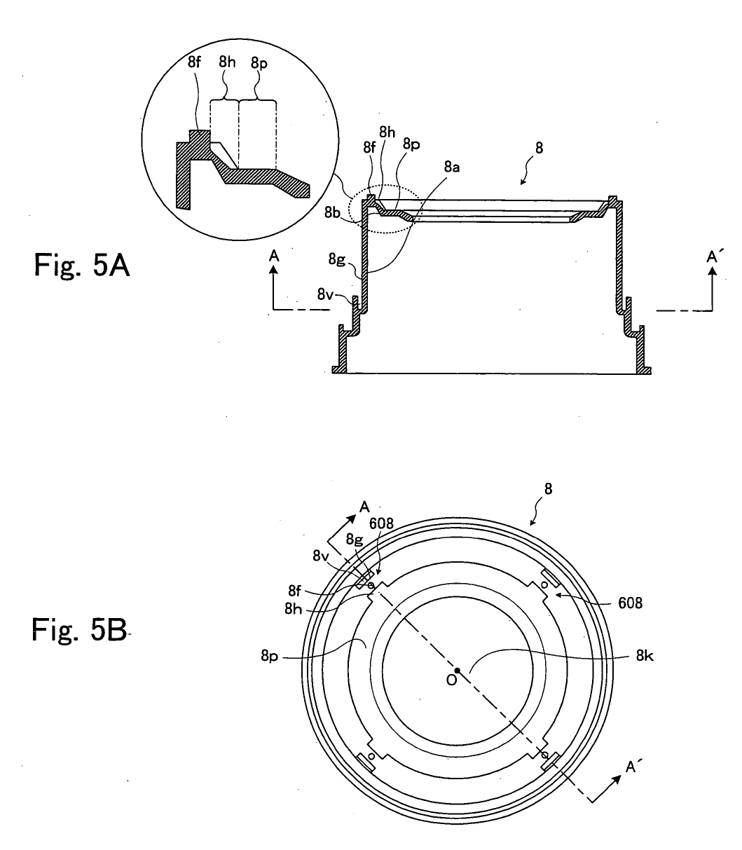

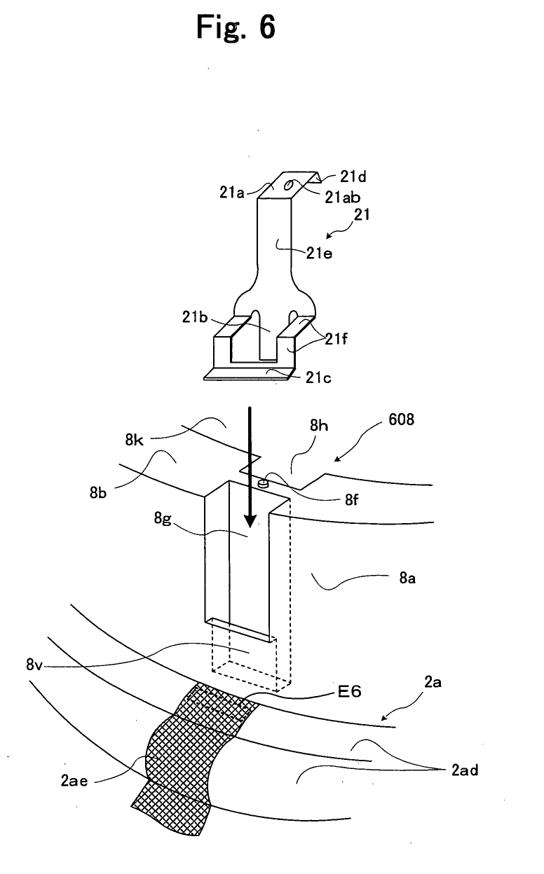

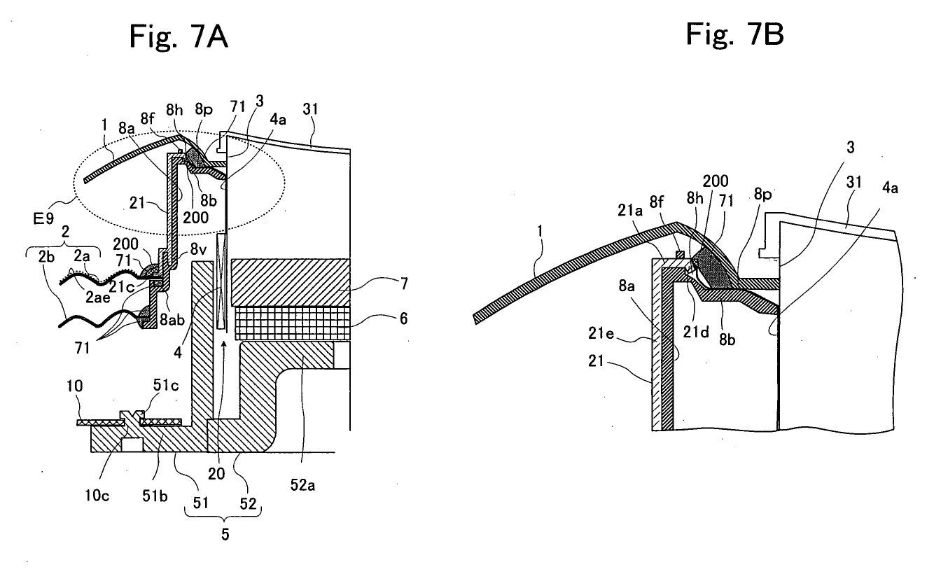

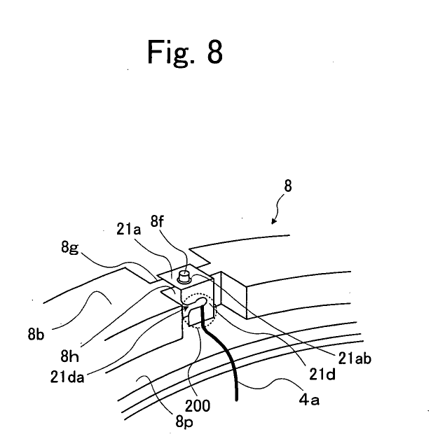

FIG. 3A shows a perspective view of the terminal member 21 according to the first embodiment. FIG. 3B shows a perspective view of an enlarged local part in the vicinity of a connecting part 21d in FIG. 3A. FIG. 3B shows an enlarged perspective view of a local part of the connecting part 21d where a slit 21da is formed. FIG. 3C shows an enlarged perspective view corresponding to the local part in the vicinity of the connecting part 21d of FIG. 3A. FIG. 3C also shows an enlarged perspective view of the local part of the connecting part 21d with a hole 21db formed, which is applicable to the terminal member 21. FIG. 4 shows a perspective view of the connecting member 8 according to the first embodiment. FIG. 5B shows a plane view of the connecting member 8 according to the first embodiment. FIG. 5A shows a sectional view taken along the cut line A-A′ in FIG. 5B, and a sectional view of an enlarged part shown by the broken line in FIG. 5A. FIG. 6 shows a perspective view of an enlarged local part in the vicinity of a terminal mounting part of the connecting member 8. FIG. 6 is also a view explaining a method for mounting the terminal member 21 to the connecting member 8. FIG. 7A is an enlarged sectional view of a local part of the speaker device 100 in the state in which the terminal member 21 is mounted to the connecting member 8. FIG. 7B shows an enlarged sectional view of a part of a region E9 in FIG. 7A. FIG. 8 shows an enlarged perspective view of a local part in the vicinity of the connecting portions of the connecting part 21d and the connecting member 8. FIG. 8 is a view explaining a method for connecting the connecting part 21d and the lead wire 4a of the voice coil 4.

[Construction of Terminal Member]

First, referring to FIG. 3, a construction of the terminal member 21 according to the first embodiment will be explained in detail. The terminal member 21 includes a ceiling wall 21a, a connecting part 21d, a raised wall 21e, a fixing part 21b, bent parts 21f and a connecting part 21c.

The ceiling wall 21a is formed into a substantially rectangular shape, and has a hole 21ab substantially in its center. A projecting portion 8f of the connecting member 8 which will be described later is inserted into this hole 21ab. The connecting part 21d is formed by being folded to a lower side from one end side of the ceiling wall 21a. A slit 21da is formed in the connecting part 21d as shown in FIG. 3B. A lead wire 4a of the voice coil 4 is wound around this slit 21da. Thereby, the terminal member 21 and the lead wire 4a of the voice coil 4 are electrically connected. Without being limited to this, a hole 21db may be formed in the connecting part 21d as shown in FIG. 3C. In this case, the lead wire 4a of the voice coil 4 is wound around this hole 21db. The raised wall 21e extends substantially perpendicularly from the other end side of the ceiling wall 21a to the lower side. The fixing part 21b is formed into a substantially rectangular shape, and extends downward from the lower end portion of the raised wall 21e. The fixing part 21b is inserted into a groove 8v of the connecting member 8 which will be described later. The bent part 21f extends substantially perpendicularly to an outside from the lower end part side of the raised wall 21a, namely, extends to the opposite side from the direction in which the ceiling wall 21a extends, and is bent substantially perpendicularly to the down side at a predetermined position. The connecting part 21c extends substantially perpendicularly from the lower end portion side of the bent parts 21f to the outside, namely, extends in the opposite side of the direction in which the ceiling wall 21a extends. This connecting part 21c is connected to a conductive member 2ae of the conductive damper 2a.

[Construction of Connecting Member]

Next, referring to FIGS. 4 and 5, the connecting member 8 according to the first embodiment will be explained in detail.

The basic construction of the connecting member 8 is as described above. The connecting member 8 further includes an opening 8k, projecting portions 8f, slit portions 8h, grooves 8v and a flat surface 8p. A plurality of sets of projecting parts 8f, slit parts 8h, slit parts 8g and grooves 8v (hereinafter also called “a set of terminal mounting part 608”) are formed in a circumferential direction of the connecting member 8 with constant spaces apart from each other. One terminal members 21 is mounted to one set of terminal mounting part 608.

The opening 8k is formed substantially at the center of the connecting member 8. The voice coil bobbin 3 is inserted into this opening 8k. The projecting portion 8f is formed into a substantially columnar shape, and projects upward from an upper end surface of the bent portion 8b. The projecting portion 8f is inserted into the hole 21ab of the terminal member 21. The slit portion 8h is the slit formed on the upper end surface of the bent portion 8b at the side of the center axis O. The connecting part 21d of the terminal member 21 is disposed in this slit portion 8h. The slit portion 8g is the slit formed in an outer peripheral wall of the cylindrical portion 8a. The slit portion 8g is formed from the upper end portion of the outer peripheral wall of the cylindrical portion 8a to the vicinity of the lower end of the outer peripheral wall of the cylinder portion 8a. The raised wall 21e of the terminal member 21 is disposed in this slip portion 8g. The groove 8v is the groove formed at the lower position of the slit portion 8g. The fixing part 21b of the terminal member 21 is inserted into this groove 8v. The flat surface 8p of the bent portion 8b has the flatness and the inner peripheral portion of the diaphragm 1 is mounted to it. The flat surface 8p and the slit portion 8h (white portion) are respectively the zones shown in the enlarged sectional view of FIG. 5A.

Next, referring to FIG. 6, a method for mounting the terminal member 21 to the connecting member 8 will be explained.

In order to mount the terminal member 21 to the connecting member 8, the terminal member 21 is mounted to a set of terminal mounting part 608 in the arrow direction in the drawing. At this time, the projecting portion 8f of the connecting member 8 is inserted into the hole 21ab of the terminal member 21, and the fixing part 21b of the terminal member 21 is inserted into the groove 8v of the connecting member 8. The upper end portion side of the terminal member 21 is fixed to the connecting member 8 by the projecting portion 8f of the connecting member 8, and a lower end portion side of the terminal member 21 is fixed to the connecting member 8 by the fixing part 21b of the terminal member 21. Thereby, the terminal member 21 is reliably fixed to the connecting member 8, and an undersurface of the connecting part 21c of the terminal member 21 is connected to a conductive member 2ae (the portion of the region E6) at the side of the inner peripheral edge portion of the conductive damper 2a.

Thereby, according to the fixing structure of the terminal member 21 and the connecting member 8, the terminal member 21 can be effectively prevented from lifting from the connecting member 8, and the soldering operation of the connecting part 21c and the conductive damper 2a can be easily performed.

The terminal member 21 is thus mounted to the connecting member 8, and the state in which the components of the speaker device 100 are mounted is shown in FIG. 7.

In such a state, as shown in FIG. 7B and FIG. 8, the connecting part 21d is disposed in the slit portion 8h, and the projecting portion 8f of the connecting member 8 is inserted into the hole 21ab of the connecting part 21. The undersurface of the ceiling wall 21a is in contact with the upper end surface of the bent portion 8b. The raised wall 21e is disposed in the slit portion 8g of the connecting member 8. The fixing part 21b is inserted into the groove 8v. The lead wire 4a lead out from the voice coil 4 is lead along the outer peripheral wall of the voice coil bobbin 3, the top surface of the bent portion 8b and the slit portion 8h, and is electrically connected to the connecting part 21d of the terminal member 21 by soldering as shown in FIG. 7B and FIG. 8. Meanwhile, the connecting part 21c of the terminal member 21 is electrically connected to the conductive member 2ae (see the broken line portion) at the side of the inner peripheral edge portion of the conductive damper 2a by soldering as shown in FIG. 7A.

As shown in FIG. 7B, the adhesive 71 is applied between the connecting part 21d of the terminal member 21 connected to the lead wire 4a via the soldering 200 and the bent portion 8b of the connecting member 8 and the inner peripheral portion of the diaphragm 1. As the applying method of this adhesive 71, the bent portion 8b of the connecting member 8 and the inner peripheral edge portion of the diaphragm 1 are bonded with the adhesive 71 and at the same time, the upper end portion of the terminal member 21 is bonded to them. Thereby, the upper end portion of the terminal member 21, the connecting member 8 and the diaphragm 1 are firmly bonded.

As shown in FIG. 7A, the adhesive 71 is applied between the connecting part 21c of the terminal member 21 connected to the conductive member 2ae via the soldering 200 and the connecting member 8 (not shown) in the vicinity of the connecting part 21c, and the conductive member 2ae. As the applying method of this adhesive 71, at the same time when the outer peripheral wall of the cylinder portion 8a of the connecting member 8 and the inner peripheral portion of the conductive damper 2a are bonded with the adhesive 71, the connecting part 21c of the terminal member 21 is bonded to them. Thereby, the lower end portion of the terminal member 21, the connecting member 8 and the conductive damper 2a are firmly bonded.

Therefore, the upper end portion of the terminal member 21, the connecting member 8 and the diaphragm 1 can be fixed by one applying operation of the adhesive 71, and the lower end portion of the terminal member 21, the connecting member 8 and the conductive damper 2a can be fixed. Thereby, the number of assembling steps of the speaker device 100 can be reduced.

### Second Embodiment

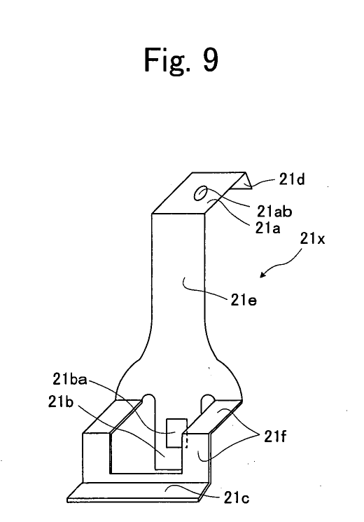

Next, referring to FIGS. 9 to 13, a fixing structure and the like of a terminal member 21x and a connecting member 8x which make the characteristics of the present invention will be described in detail. The second embodiment provides the same effects as the first embodiment by making fixation of the terminal member 21x and the connecting member 8x firmer than the first embodiment.

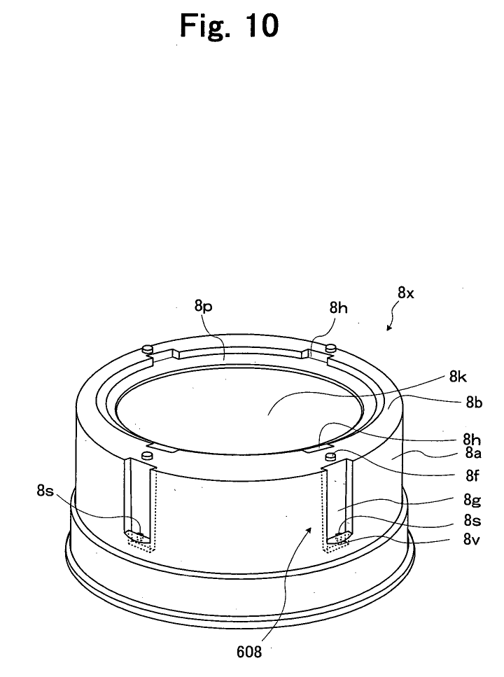

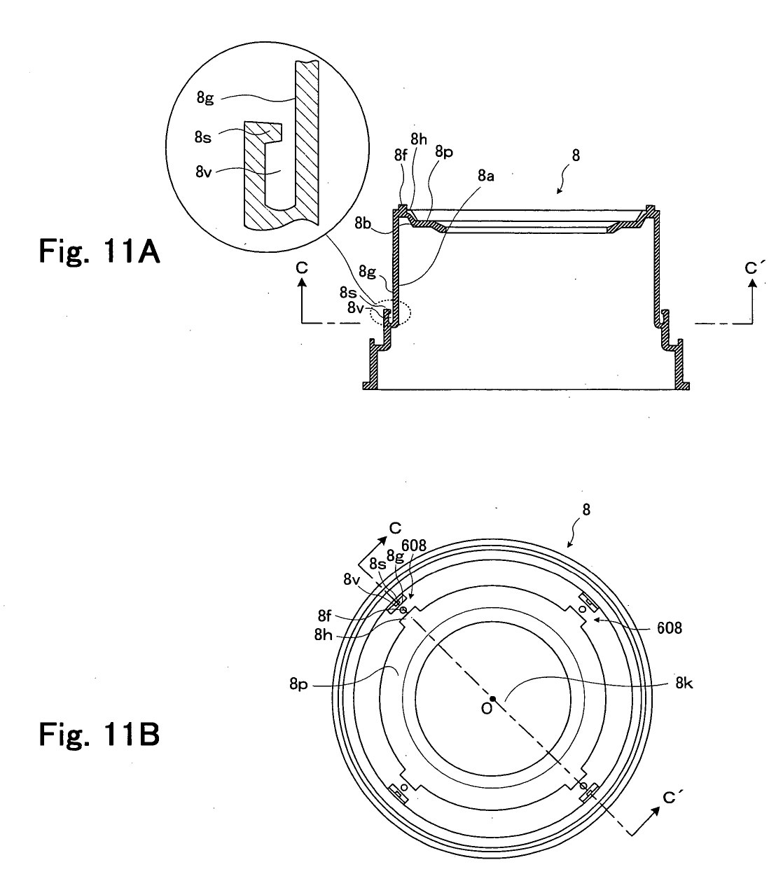

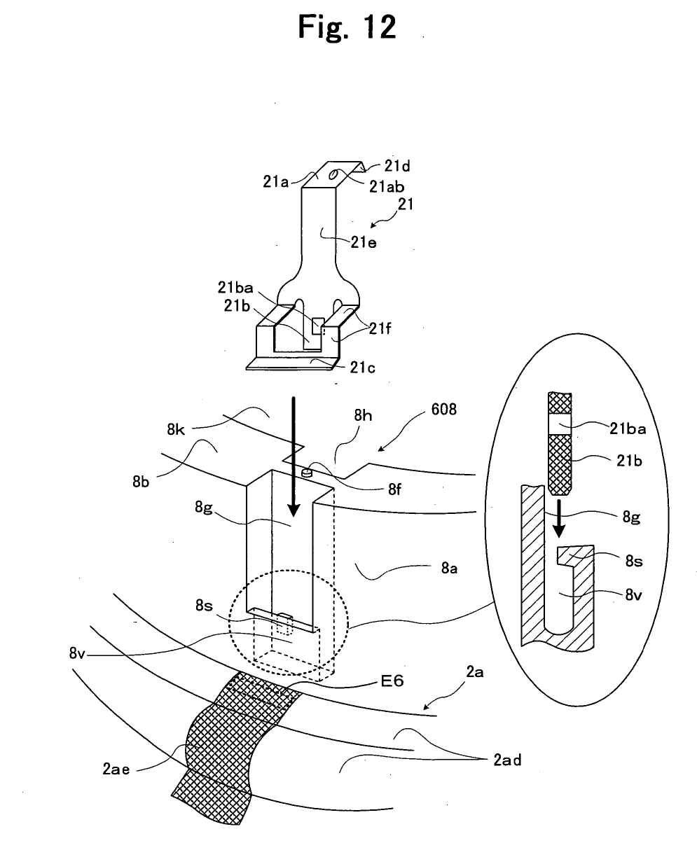

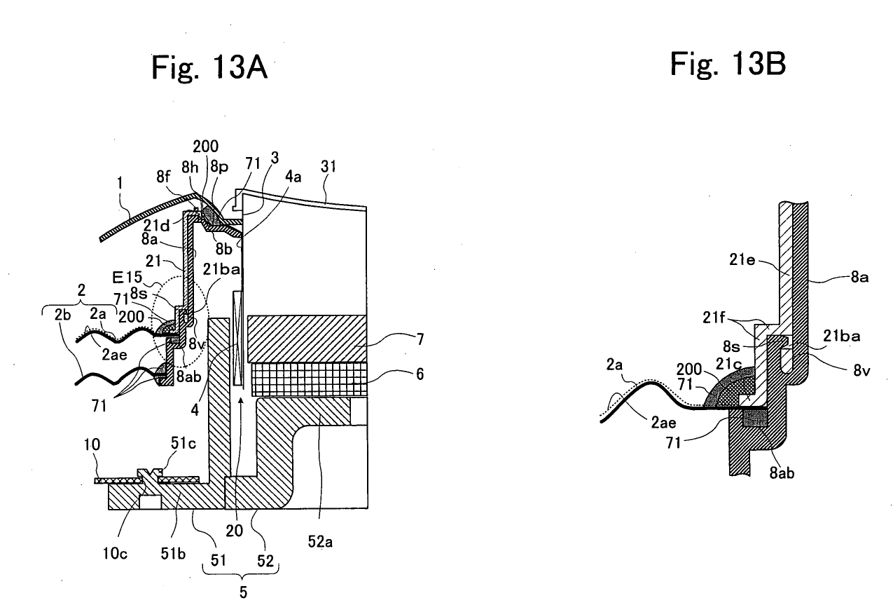

FIG. 9 shows a perspective view of the terminal member 21x according to the second embodiment. FIG. 10 shows a perspective view of the connecting member 8x according to the second embodiment. FIG. 11B shows a plane view of the connecting member 8x according to the second embodiment. FIG. 11A shows a sectional view taken along the cut line C-C′ in FIG. 11B, and an enlarged sectional view of a portion of the broken line of FIG. 11A. FIG. 12 is an enlarged perspective view of a local part in the vicinity of a terminal mounting portion of the connecting member 8x, and an enlarged sectional view of a broken line portion of FIG. 12. FIG. 12 is also a view for explaining a method for mounting the terminal member 21x to the connecting member 8x. FIG. 13A shows an enlarged sectional view of a local part of the speaker device 100 in the state in which the terminal member 21x is mounted to the connecting member 8x. FIG. 13B shows an enlarged sectional view of a portion of a region E15 of FIG. 13A.

[Construction of Terminal Member 21x]

First, referring to FIG. 9, the construction of the terminal member 21x according to the second embodiment will be explained. In explaining the terminal member 21x, the same components as the components of the terminal member 21 according to the first embodiment are given the same reference numerals and characters, and the explanation thereof will be omitted.

The terminal member 21x has substantially the same construction as the terminal member 21 of the first embodiment. However, the terminal member 21x differs from the terminal member 21 in that it has an opening 21ba substantially at a center of the fixing part 21b. A projecting portion 8s of the connecting member 8x which will be described later is inserted into this opening 21ba.

[Construction of Connecting Member 8x]

Next, referring to FIGS. 10 and 11, the construction of the connecting member 8x according to the second embodiment will be explained. In explaining the connecting member 8x, the same components as the components of the connecting member 8 according to the first embodiment are given the same reference numerals and characters, and the explanation thereof will be omitted.

The connecting member 8x has substantially the same construction as the connecting member 8 of the first embodiment. However, the connecting member 8x differs from the connecting member 8 in that it has the projecting portion 8s formed into a substantially rectangular column shape at the side wall of the outer side of the groove 8v as shown. This projecting portion 8s projects to the side of the center axis O as shown in FIG. 11B. This projecting portion 8s has the function of fixing the fixing part 21b of the terminal member 21x by being inserted into the opening 21ba of the terminal member 21x.

Next, referring to FIG. 12, a method for mounting the terminal member 21x to the connecting member 8x will be explained.

In order to mount the terminal member 21x to the connecting member 8x, the terminal member 21x is mounted to a set of the terminal mounting part 608 in the direction of the arrow in the drawing. At this time, the projecting portion 8f of the connecting member 8x is inserted into the hole 21ab of the terminal member 21x. Thereby, an upper end portion side of the terminal member 21x is fixed to the connecting member 8x. As shown in the enlarged sectional view in the drawing, the fixed part 21b of the terminal member 21x is inserted into the groove 8v of the connecting member 8x in the arrow direction. Thereby, the projecting portion 8s is fitted into the opening 21ba. Thereby, the fixing part 21b of the terminal member 21x is fixed by the projecting portion 8s and the groove 8v of the connecting member 8x. Thereby, according to this fixing structure, the fixing strength of the terminal member 21x and the connecting member 8x can be enhanced more as compared with the first embodiment. Thereby, the undersurface of the connecting part 21c of the terminal member 21x is connected to the conductive member 2ae (portion of the region E6) at the side of the inner peripheral edge portion of the conductive damper 2a. Thus, according to the fixing structure of this terminal member 21x and the connecting member 8x, the terminal member 21x can be effectively prevented from lifting from the connecting member 8x as is understood by referring to FIG. 13B. Further, the soldering operation of the connecting part 21c and the conductive damper 2a can be easily performed. The state in which the terminal member 21x is thus mounted to the connecting member 8x and the components of the speaker device 100 are mounted is shown in FIG. 13A. The speaker device shown in FIG. 13A has substantially the same construction as the speaker device of the first embodiment shown in FIG. 7A, and therefore, the explanation will be omitted.

According to the fixing structure of the terminal member 21x and the connecting member 8x according to the second embodiment, the same effect as the first embodiment can be obtained, and the number of assembling steps of the speaker device can be reduced.

[Modified Example of the Connecting Member]

As for the construction of the groove of the connecting member which can fix the above described terminal members 21 and 21x, various modifications can be made.

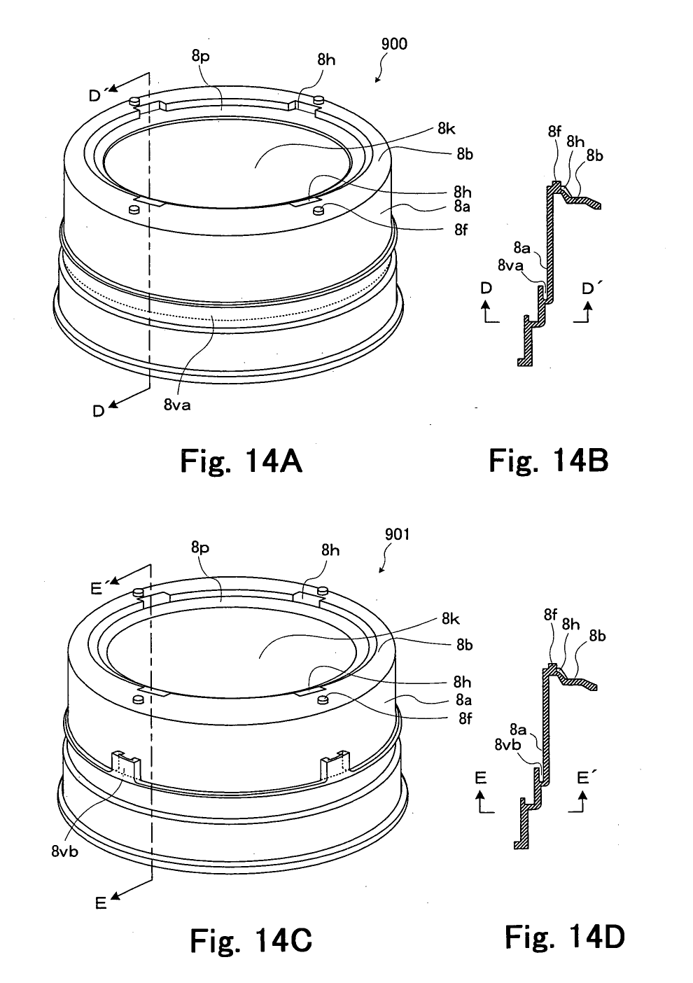

For example, in the connecting members 8 and 8x according to the above described first and second embodiments, the groove 8v is formed for each set of the terminal mounting parts 608, but without being limited to this, the groove may be formed on the entire circumference of the outer peripheral wall of the cylinder portion 8a of the connecting members 8 and 8x. FIG. 14A schematically shows a perspective view of a connecting member 900 in which such a groove 8va is formed. FIG. 14B shows a sectional view of a local part taken along the cut line D-D′ of FIG. 14A.

The connecting member 900 has substantially the same construction as the connecting members 8 and 8x according to the first and second embodiments, but does not have the slit portion 8g. Instead, the groove 8va is formed in the vicinity of the lower end of the cylinder portion 8a along the circumferential direction of the outer peripheral wall of the cylinder portion 8a. The fixing parts 21b of the terminal members 21 or the like are inserted into this groove 8va. The mounting state of the terminal member 21 or the like to the connecting member 900 is omitted from the illustration. Thereby, the lower end part of the terminal member 21 or the like can be fixed, and the same effects as the connecting members 8 and 8x according to the first and second embodiments can be obtained. Further, when the mold for the connecting member 900 is manufactured, the groove 8va can be worked by lathe turning, and reduction in the cost of the mold can be achieved.

Various modifications can be made for the shape and the like of the groove formed in the connecting member. FIG. 14C schematically shows a perspective view of a connecting member 901 having one mode of such a groove. FIG. 14D shows a sectional view of a local part taken along the cut line E-E′ of FIG. 14A.

The connecting member 901 has substantially the same construction as the connecting members 8 and 8x according to the first and second embodiments, but does not have the slit portion 8g. Instead, the connecting member 901 has grooves 8vb formed into the shape shown in the drawings. The fixing part 21b of the terminal member 21 or the like is inserted into this groove 8vb. The mounting state of the terminal member 21 or the like to the connecting member 901 is omitted from the illustration. Thereby, the lower end portion of the terminal member 21 or the like can be fixed, and the same effects as the connecting members 8 and 8x according to the first and second embodiments can be obtained.

[Other Application Examples]

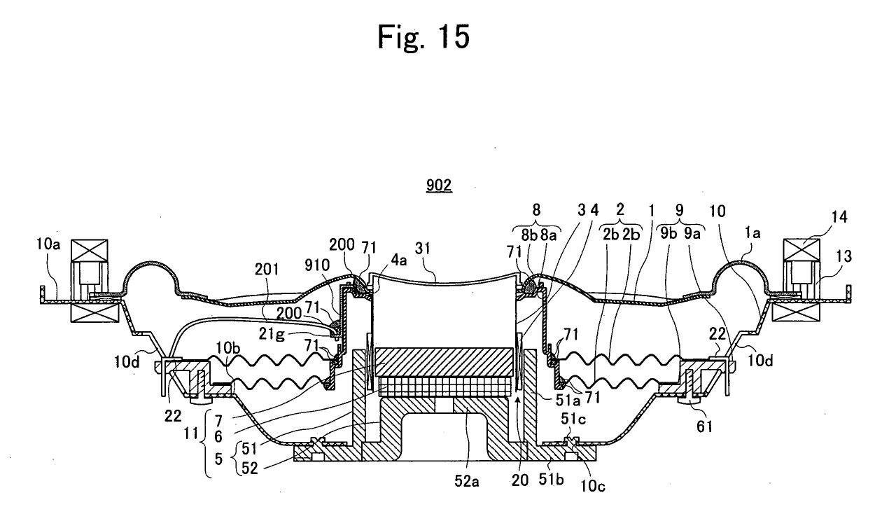

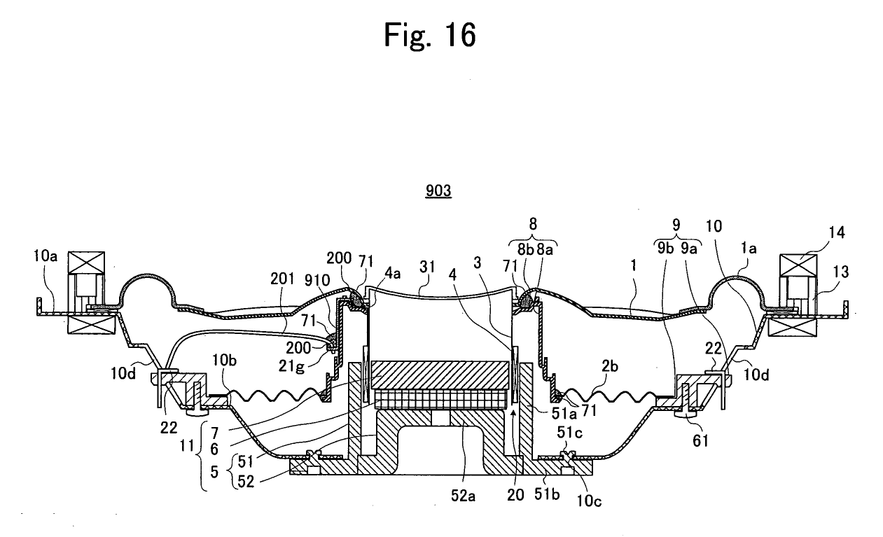

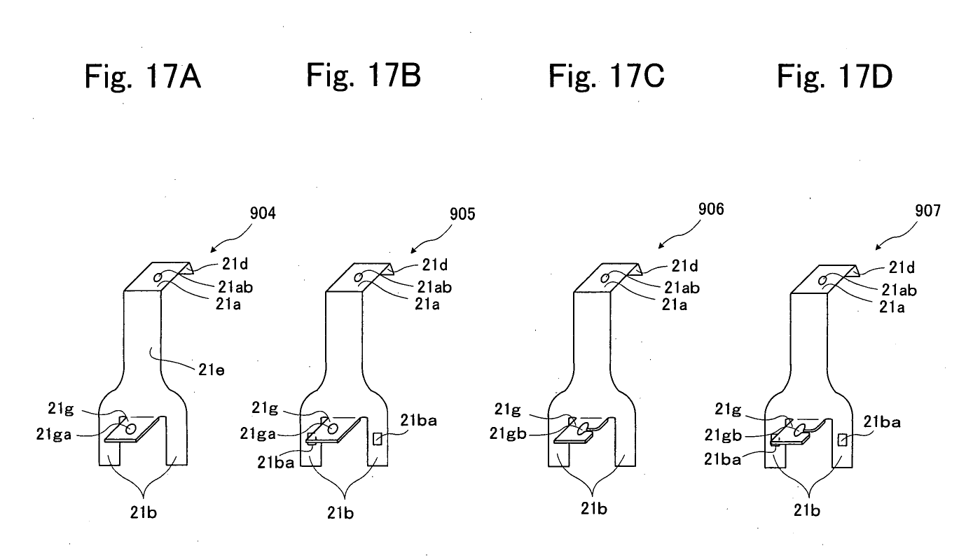

In the above described first and second embodiments, the present invention is applied to the speaker device 100 of the type in which the electric signal from the amplifier side is inputted into the voice coil 4 side through the conductive damper 2a and the like. However, without being limited to this, the present invention can also be applied to speakers 902 and 903 of a type in which the electric signal from the amplifier side is inputted to the voice coil 4 side through a tinsel cord 201 and the like as shown in FIGS. 15 and 16. FIG. 15 shows a sectional view of a speaker device 902 having the tinsel cord 201 and a plurality of ordinary dampers 2. FIG. 16 shows a sectional view of a speaker device 903 having the tinsel cord 201 and one ordinary damper 2. FIGS. 17A to 17D are perspective views schematically showing the constructions of the terminal members 904 to 907 applicable to the speaker devices 902 and 903, respectively.

Prior to the explanation of the constructions of the speaker devices 902 and 903, the constructions of the terminal members 904 to 907 will be explained. FIG. 17A shows a perspective view of the terminal member 904. FIG. 17B shows a perspective view of the terminal member 905. FIG. 17C shows a perspective view of the terminal member 906. FIG. 17D shows a perspective view of the terminal member 907.

First, the construction of the terminal member 904 will be explained. Compared with the above described terminal member 21, the terminal member 904 does not have the bent part 21f and the connecting part 21c which are the components of the terminal member 21. Instead, the terminal member 904 has a connecting part 21g and a plurality of fixing parts 21b. The connecting part 21g extends to the outside from the lower end portion of the raised wall 21e, namely, to the opposite side of the direction in which the ceiling wall 21a extends as shown in FIG. 17A. A hole 21ga is formed substantially at a center of the connecting part 21g. One end side of the tinsel cord 201 is wound around this hole 21ga. A plurality of fixing parts 21b are inserted into the groove 8v of the connecting member 8. In this case, it is necessary to form the groove 8v to be a slightly wide so that a plurality of fixing parts 21b can be inserted into the groove 8v.

Next, a construction of the terminal member 905 will be explained. The terminal member 905 has substantially the same construction as the terminal member 904. However, the terminal member 905 has holes 21ba formed substantially at a center of the connecting parts 21b, unlike the terminal member 904. The projecting portion 8s formed inside the groove 8v of the connecting member 8 is inserted into this hole 21ba. In this case, it is necessary to form the groove 8v to be slightly wide so that a plurality of fixing parts 21b can be inserted into the groove 8v. At the same time as this, it is necessary to form a plurality of projecting parts 8s on the side wall of the outside of the groove 8v corresponding to the respective holes 21ba. Thereby, the lower end portion of the terminal member 905 can be reliably fixed to the connecting member 8.

Next, a construction of the terminal member 906 will be explained. The terminal member 906 has substantially the same construction as the terminal member 904. However, the terminal member 906 has a slit 21gb formed in the connecting part 21g instead of the hole 21ga unlike the terminal member 904. One end side of the tinsel cord 201 is wound around this slit 21gb.

Next, a construction of the terminal member 907 will be explained. The terminal member 907 has substantially the same construction as the terminal member 906. However, the terminal member 907 has holes 21ba formed substantially at the center of the connecting parts 21b, unlike the terminal member 906. The projecting portion 8s formed in the groove 8v of the connecting member 8 is inserted into this hole 21ba. In this case, it is necessary to form the groove 8v slightly wide so that a plurality of fixing parts 21b can be inserted. At the same time, it is necessary to form a plurality of projecting parts 8s at the side wall of the outside of the groove 8v corresponding to each of the holes 21ba. Thereby, the lower end portion of the terminal member 907 can be reliably fixed to the connecting member 8.

If any one of the terminal members (hereinafter, called “terminal member 910”) of the terminal members 904 to 907 described above is applied to the speaker device 902 or 903, the tinsel cord 201 and the terminal member 910 can be electrically connected easily by winding one end side of the tinsel cord 201 around the hole 21ga or the slit 21gb.

Next, referring to FIG. 15 and FIG. 16, the construction or the like of the speaker device 902 or 903 to which such a terminal member 910 is applied will be briefly described.

The speaker device 902 has substantially the same construction as the speaker device 100. However, the speaker device 902 does not have the conductive damper 2a unlike the speaker device 100. Instead, the speaker device 902 has a plurality of ordinary dampers 2b and the tinsel cord 201. Therefore, in this speaker device 902, the terminal member 22 connected to the amplifier side, the tinsel cord 201, the terminal member 910 and the voice coil 4 are electrically connected.

Namely, as shown in the drawing, the one end side of the tinsel cord 201 is connected to the connecting part 21g of the terminal member 910. The contact portions of the connecting part 21g and the tinsel cord 201 are soldered. Meanwhile, the other end side of the tinsel cord 201 is connected to the one end side of the terminal member 22. Thereby, in the speaker device 902, the relay wiring at the amplifier side, the terminal member 22, the tinsel cord 201, the terminal member 910 and the lead wire 4a of the voice coil 4 are electrically connected.

In this speaker device 902, the terminal member 910 is reliably fixed to the connecting member 8 by the same method as the above described first and second embodiments. Thereby, in the speaker device 902, at the same time when the bent portion 8b of the connecting member 8 and the inner peripheral edge portion of the diaphragm 1 are bonded with the adhesive 71, the upper end portion of the terminal member 910 can be bonded to them. After the tinsel cord 201 is soldered to the connecting part 21g of the terminal member 910, this portion is reinforced with the adhesive 71 and at the same time, the terminal member 910 and the tinsel cord 201 or the like can be bonded. Therefore, by one applying operation of the adhesive 71, the upper end portion of the terminal member 910, the connecting member 8 and the diaphragm 1 can be fixed, and the connecting part 21g of the terminal member 910 and the tinsel cord 201 or the like can be fixed. Thereby, the number of assembling steps of the speaker device 902 can be reduced.

The speaker device 903 has substantially the same construction as the speaker device 902. However, the speaker device 903 has only one ordinary damper 2, and differs from the speaker device 902 in this respect. Namely, the present invention is also applicable to the speaker device 903 having one ordinary damper 2. Thus, in the speaker device 903, the same effect as the above described speaker device 902 can be obtained.

[Manufacturing Method of Speaker Device 100]

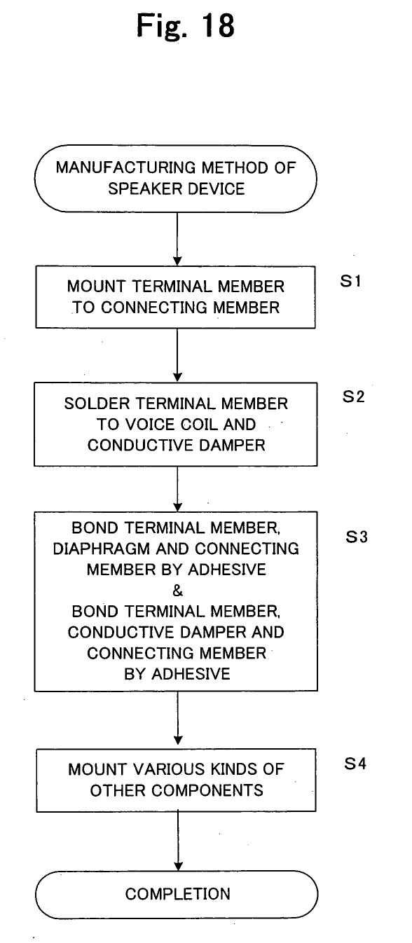

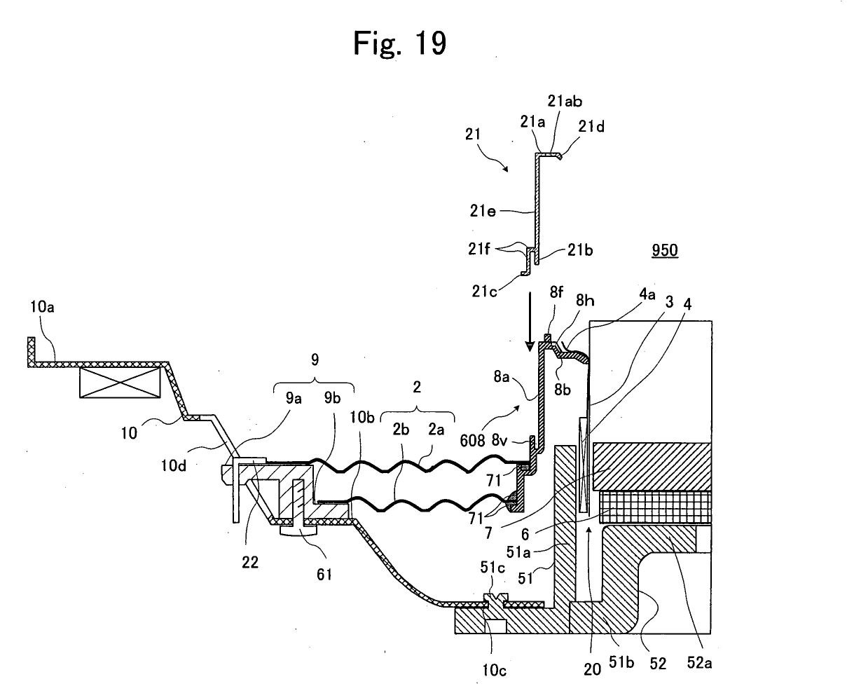

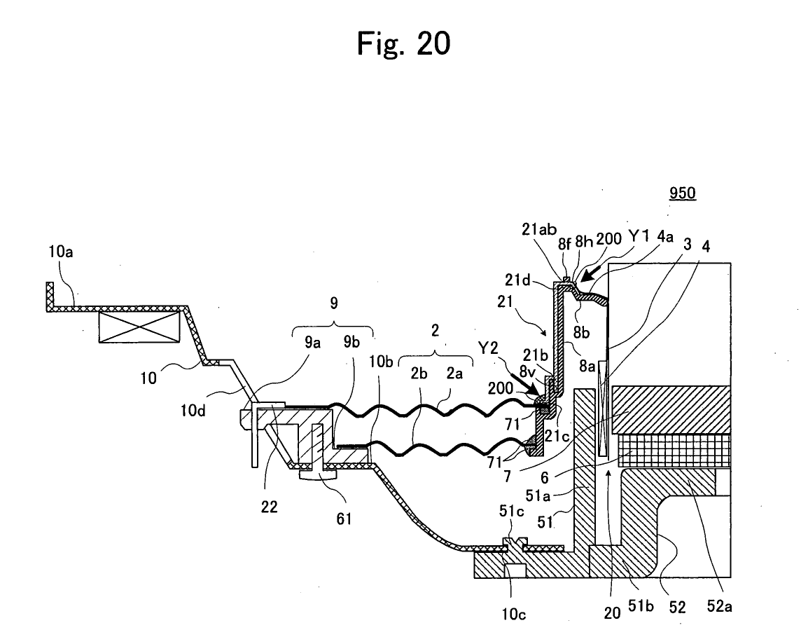

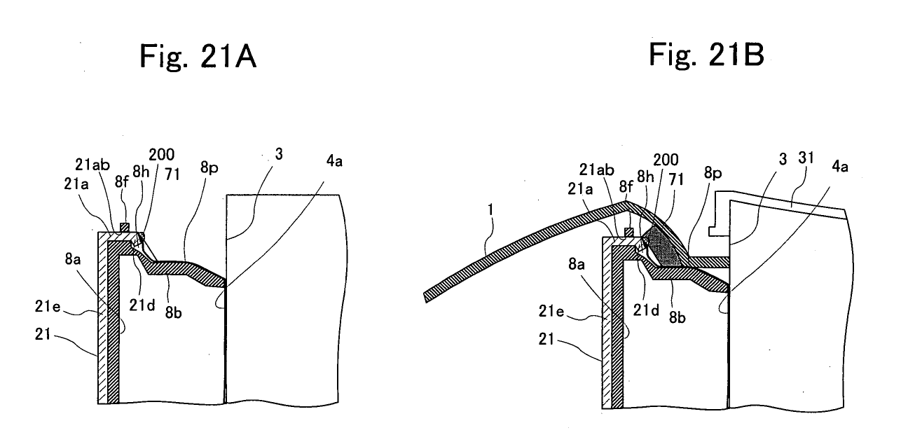

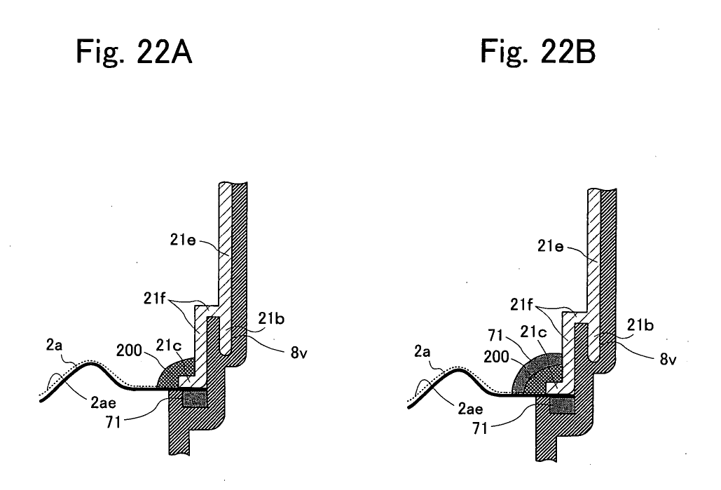

Next, a manufacturing method of the speaker device 100 of the present invention will be described by referring to FIGS. 18 to 22. FIG. 18 shows a flow chart of the manufacturing method of the speaker device 100. FIGS. 19 and 20 show a manufacturing process of the speaker device 100. FIG. 21A shows an enlarged sectional view of a local part in the vicinity of the arrow Y1 in FIG. 20. FIG. 21A is also the enlarged sectional view of a local part of a state in which the lead wire 4a of the voice coil 4 and the connecting part 21d of the terminal member 21 are soldered with the soldering 200. FIG. 21B is an enlarged sectional view of the local part corresponding to FIG. 21A. FIG. 21B is also the enlarged sectional view of the local part in the state in which portions of the connecting part 21d and the lead wire 4a connected by soldering is reinforced with the adhesive 71. FIG. 22A shows an enlarged sectional view of a local part in the vicinity of the arrow Y2 in FIG. 20. FIG. 22A is also an enlarged sectional view of a local part in the state in which the conductive member 2ae of the conductive damper 2a and the connecting part 21c of the terminal member 21 are soldered. FIG. 22B is an enlarged sectional view of the local part corresponding to FIG. 22A. FIG. 22B is also an enlarged sectional view of the local part in the state in which the portions of the connecting part 21c and the conductive member 2ae connected by soldering is reinforced with the adhesive 71.

First, as shown in FIG. 19, in the speaker unit 950 which is in the state it is assembled to some extent, the terminal member 21 is mounted to the terminal mounting part 608 of the connecting member 8 (step S1). More specifically, the projecting portion 8f of the connecting member 8 is inserted into the hole 21ab of the terminal member 21 and the fixing part 21b of the terminal member 21 is inserted into the groove 8v of the connecting member 8. Thereby, as shown in FIG. 20, the terminal member 21 is fixed to the connecting member 8 in the state in which the connecting part 21c of the terminal member 21 is connected to the conductive member 2ae of the conductive damper 2a. Thus, according to the fixing structure of this terminal member 21 and the connecting member 8, the terminal member 21 and the connecting member 8 are physically fixed at the two positions as described above. Therefore, the terminal member 21 does not lift from the connecting member 8, and the soldering operation of the connecting part 21c of the terminal member 21 and the conductive member 2ae of the conductive damper 2a can be easily performed.

Next, the terminal member is soldered to the lead wire 4a of the voice coil 4 and the conductive damper 2a, respectively (step S2). More specifically, the lead wire 4a of the voice coil 4 is wound around the hole 21ab of the connecting part 21a of the terminal member 21 (see FIG. 8). With this, soldering is performed for this portion as shown in FIG. 20 and FIG. 21A. As shown in FIG. 20 and FIG. 22A, soldering is performed for the portions of the connecting part 21c of the terminal member 21 and the conductive member 2ae of the conductive damper 2a. Thereby, the voice coil 4 and the conductive damper 2a are electrically connected via the terminal member 21.

Next, as shown in FIG. 21B, at the same time when the bent portion 8b of the connecting member 8 and the inner peripheral edge portion of the diaphragm 1 are bonded with the adhesive 71, the upper end portion of the terminal member 21 is bonded to them (step S3). As shown in FIG. 22B, at the same time when the outer peripheral wall of the cylinder portion 8a of the connecting member 8 and the inner peripheral edge portion of the conductive damper 2a are bonded with the adhesive 71, the lower end portion of the terminal member 21 is bonded to them (step S3). Thus, by one applying operation of the adhesive 71, the upper end portion of the terminal member 21, the connecting member 8 and the diaphragm 1 can be fixed, and the lower end portion of the terminal member 21, the connecting member 8 and the conductive damper 2a can be fixed. Thereby, the number of assembling steps of the speaker device 100 can be reduced.

Next, by mounting the various kinds of other components, the speaker device 100 shown in FIG. 1 is manufactured.

What is claimed is:

1. A speaker device comprising:
a frame;
a damper having an outer peripheral edge portion supported by the frame;
a connecting member mounted to the damper and movably supporting a voice coil bobbin; and
a terminal member electrically connected to an amplifier side and a voice coil side,
wherein a projecting part projecting upward is formed at an upper end portion of the connecting member and a groove is formed in a lower end portion of the connecting member,
wherein a hole in which the projecting part is inserted is formed in an upper end portion of the terminal member and a fixing part which is inserted into the groove is formed at a lower end portion of the terminal member, and
wherein the terminal member is mounted to the connecting member in a state in which the projecting part is inserted into the hole and the fixing part is inserted into the groove.

2. The speaker device according to claim 1, wherein a projecting part projecting to a side of a center axis of the connecting member is formed in the groove, wherein an opening into which the projecting part is inserted is formed in the fixing part, and wherein the projecting part is inserted into the opening.

3. The speaker device according to claim 1, wherein a connecting part of the terminal member is connected to a conductive member of a conductive damper or a tinsel cord.

4. The speaker device according to claim 1, wherein an inner peripheral edge portion of a diaphragm is disposed at the upper end portion of the terminal member.

5. A method of manufacturing a speaker device comprising the steps of:
fixing a terminal member to a connecting member by inserting a projecting part formed at an upper end portion of the connecting member into a hole formed in an upper end portion of the terminal member and inserting a fixing part formed at a lower end portion of the terminal member into a groove formed at a lower end portion of the connecting member;
soldering a connecting part of the terminal member fixed to the connecting member and a conductive member of a conductive damper and soldering a lead wire of a voice coil to the upper end portion of the terminal member;
simultaneously bonding the upper end portion of the terminal member, the upper end portion of the connecting member and the inner peripheral edge portion of the diaphragm; and
simultaneously bonding the lower end portion of the terminal member, the lower end portion of the connecting member and the inner peripheral edge portion of the conductive damper.
